(19) United States
(12) Patent Application Publication
(10) Pub. No.: US 2010/0054192 A1
(43) Pub. Date: Mar. 4, 2010

(54) METHODS OF ESTIMATING AVAILABLE BANDWIDTH AND DELAY IN MULTI-CHANNEL MULTI-INTERFACE BASED WIRELESS AD-HOC NETWORK AND METHOD OF RELAYING ROUTE REQUEST MESSAGE USING THE SAME

(76) Inventors: Young-Han Kim, Seocho-gu (KR); Sung-Won Ko, Grimpo-si (KR)

Correspondence Address: SHERR & VAUGHN, PLLC, 620 HERNDON PARKWAY, SUITE 320, HERNDON, VA, 20170, US

(21) Appl. No.: 12/199,801

(22) Filed: Aug. 28, 2008

(51) Int. Cl. H04Q 7/00

(52) U.S. Cl. 370/329

(57) ABSTRACT

Provided are methods of estimating an available bandwidth and a delay in a multi-channel multi-interface based wireless ad-hoc network, and a method of relaying a route request message using the methods. The method of relaying a route request message includes (a) receiving a first route request message including information on a required bandwidth, (b) determining whether or not a condition that a link from a node transmitting the first route request message to the intermediate node and a link from the intermediate node to one of one or more neighboring nodes both have an available bandwidth equal to or larger than the required bandwidth, is satisfied, and (c) when it is determined that the condition is satisfied, broadcasting a second route request message including the information on the required bandwidth. According to the methods, it is possible to efficiently configure a route guaranteeing Quality of Service (QoS) required for a call.

### BACKGROUND

1. Field of the Invention

The present invention relates to a method for route configuration in a wireless ad-hoc network, and more particularly, but not exclusively, to operation of a wireless node for estimating an available bandwidth of a wireless link and transmission delay of a corresponding route, and configuring a route guaranteeing Quality of Service (QoS) required for a call in a multi-channel multi-interface based wireless ad-hoc network.

2. Discussion of Related Art

In a single-channel single-interface based wireless ad-hoc network, wireless nodes have only one radio interface each and use only one Radio Frequency (RF) channel in common. The single-channel single-interface based wireless ad-hoc network cannot fully use the transmission capacity of a wireless node due to half-duplex transmission and intra-route interference.

In a multi-channel multi-interface based wireless ad-hoc network, wireless nodes each have a radio interface for transmission, i.e., a transmission interface, and a radio interface for reception, i.e., a reception interface, and select a transmission channel and a reception channel from among several RF channels admitted by the network. The multi-channel multi-interface based wireless ad-hoc network can overcome limitations of the single-channel single-interface based wireless ad-hoc network due to full-duplex transmission and little intra-route interference.

Meanwhile, to normally provide multimedia service, a route from a source node to a destination node must satisfy QoS, e.g., a required bandwidth and an admissible delay, requested by the multimedia service.

Therefore, call admission control must be performed to configure a route satisfying QoS required for a call.

Such call admission control requires an admissible delay of a corresponding route as well as methods that can be used in a wireless link using contention-based Media Access Control (MAC) for an intermediate node receiving a route request message to efficiently relay the message and for efficiently estimating an available link bandwidth.

### SUMMARY OF THE INVENTION

The present invention is directed to an operation method for a wireless node to efficiently estimate an available bandwidth of a wireless link and transmission delay of a corresponding route and configure a route guaranteeing Quality of Service (QoS) required for a call in a multi-channel multi-interface based wireless ad-hoc network.

A first aspect of the present invention provides a method for a first node to estimate an available bandwidth of a link from a second node to the first node in a multi-channel multi-interface based wireless ad-hoc network, the method comprising: (a) receiving a message broadcast from the second node and including information on an available transmission bandwidth of the second node; (b) estimating an available reception bandwidth of the first node; and (c) determining the smaller of the available transmission bandwidth and the available reception bandwidth as the available link bandwidth.

Each node in the wireless ad-hoc network may have a transmission interface, a reception interface and a control interface using different channels, and the message may be transmitted from the control interface of the second node and received by the control interface of the first node through a dedicated control channel used in common in the wireless ad-hoc network.

A second aspect of the present invention provides a method for a first node to estimate an available bandwidth of a link from the first node to a second node in a multi-channel multi-interface based wireless ad-hoc network, the method comprising: (a) receiving a message broadcast from the second node and including information on an available reception bandwidth of the second node; (b) estimating an available transmission bandwidth of the first node; and (c) determining the smaller of the available transmission bandwidth and the available reception bandwidth as the available link bandwidth.

Each node in the wireless ad-hoc network may have a transmission interface, a reception interface and a control interface using different channels, and the message may be transmitted from the control interface of the second node and received by the control interface of the first node through a dedicated control channel used in common in the wireless ad-hoc network.

A third aspect of the present invention provides a method for a first node receiving a route request message to estimate a delay of a route from a source node to the first node in a multi-channel multi-interface based wireless ad-hoc network, the method comprising: (a) receiving the route request message including information on a delay from the source node to a second node and a required bandwidth from the second node; (b) estimating an available bandwidth of a link for transmission from the second node to the first node; (c) estimating a delay of the link from the second node to the first node on the basis of the available link bandwidth and the required bandwidth; and (d) determining a sum of the estimated delay and the delay included in the route request message as the delay of the route.

A fourth aspect of the present invention provides a method for a first node receiving a route request message to estimate a delay of a route from a source node through the first node to a second node neighboring the first node in a multi-channel multi-interface based wireless ad-hoc network, the method comprising: (a) receiving the route request message including information on a required bandwidth; (b) estimating a delay of a link from the source node to the first node; (c) estimating an available bandwidth of a link from the first node to the second node; (d) estimating a delay of the link from the first node to the second node on the basis of the available link bandwidth and the required bandwidth; and (e) determining a sum of the delay estimated in step (b) and the delay estimated in step (d) as the delay of the route.

A fifth aspect of the present invention provides a method for an intermediate node to relay a route request message for route configuration in a multi-channel multi-interface based wireless ad-hoc network, the method comprising: (a) receiving a first route request message including information on a required bandwidth; (b) determining whether or not a condition that a link from a node transmitting the first route request message to the intermediate node, and a link from the intermediate node to one of one or more neighboring nodes both have an available bandwidth equal to or larger than the required bandwidth, is satisfied; and (c) when it is determined that the condition is satisfied, broadcasting a second route request message including the information on the required bandwidth.

A sixth aspect of the present invention provides a method for an intermediate node to relay a route request message for route configuration in a multi-channel multi-interface based wireless ad-hoc network, the method comprising: (a) receiving a first route request message including information on an admissible delay; (b) estimating a delay from a source node to each of one or more neighboring nodes; and (c) when one of the estimated delays is equal to or smaller than the admissible delay, broadcasting a second route request message including information on the admissible delay.

### BRIEF DESCRIPTION OF THE DRAWINGS

The above and other objects, features and advantages of the present invention will become more apparent to those of ordinary skill in the art by describing in detail exemplary embodiments thereof with reference to the attached drawings, in which:

FIG. 1 illustrates a multi-channel multi-interface based wireless ad-hoc network model according to an exemplary embodiment of the present invention;

FIG. 2 is a flowchart showing a method of relaying a route request message according to an exemplary embodiment of the present invention;

FIGS. 3A and 3B are a diagram and a table for describing the exemplary embodiment of FIG. 2;

FIGS. 4 and 5 are examples of flowcharts showing a detailed process of step 220 of FIG. 2;

FIGS. 6A to 6C illustrate a Dynamic Source Routing (DSR) scheme employing a method of configuring a route guaranteeing Quality of Service (QoS); and

FIG. 7 is a graph of throughput showing performance of a routing method according to an exemplary embodiment of the present invention.

### DETAILED DESCRIPTION OF EXEMPLARY EMBODIMENTS

Hereinafter, exemplary embodiments of the present invention will be described in detail. However, the present invention is not limited to the embodiments disclosed below but can be implemented in various modified forms. The following embodiments are described in order to fully enable those of ordinary skill in the art to embody and practice the present invention.

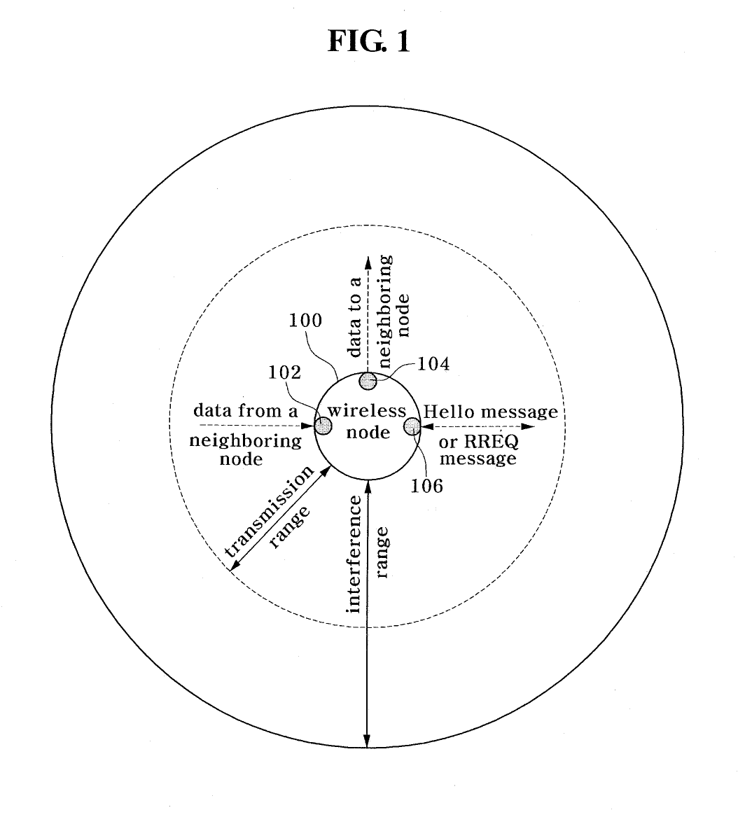

FIG. 1 illustrates a multi-channel multi-interface based wireless ad-hoc network model according to an exemplary embodiment of the present invention.

Referring to FIG. 1, a wireless node 100 has three radio interfaces 102, 104 and 106. In FIG. 1, the first radio interface 102 is a reception interface for receiving data from a neighboring node through a wireless link, the second radio interface 104 is a transmission interface for transmitting data to a neighboring node through a wireless link, and the third radio interface 106 is a control interface for transmitting/receiving control data to/from a neighboring node. Here, the control data may be, for example, a hello message and a route request message that will be described later in this specification.

Assuming that radio channels which can be used without interference are CH0, CH1, CH2 and CH3 in a network shown in FIG. 1, an exemplary embodiment of the present invention will be described below.

The third radio interface 106 uses CH0, a channel used in common in the network. More specifically, control interfaces of all the wireless nodes in the network transmit/receive control data using CH0.

Each of the first and second radio interfaces 102 and 104 selects and uses a channel, i.e., CH1, CH2 and CH3, other than the dedicated control channel used by the control interface. To enable full-duplex communication, a transmission channel used by the transmission interface, i.e., the second radio interface 104, and the reception interface, i.e., the first radio interface 102, may be selected/used differently from each other.

The first radio interface 102 may keep using the selected channel, e.g., CH1, regardless of time or a network situation, and the second radio interface 104 may select and use one, e.g., CH2, of channels, i.e., CH2 and CH3, other than the dedicated control channel and the reception channel. While using CH2, the second radio interface 104 can change the transmission channel from CH2 to CH3 due to a wireless link situation or for appropriate transmission to a neighboring node (not shown). For example, when the wireless node 100 must transmit data to the neighboring node whose reception channel is CH3, it changes its transmission channel from CH2 to CH3 and then transmits the data to the neighboring node.

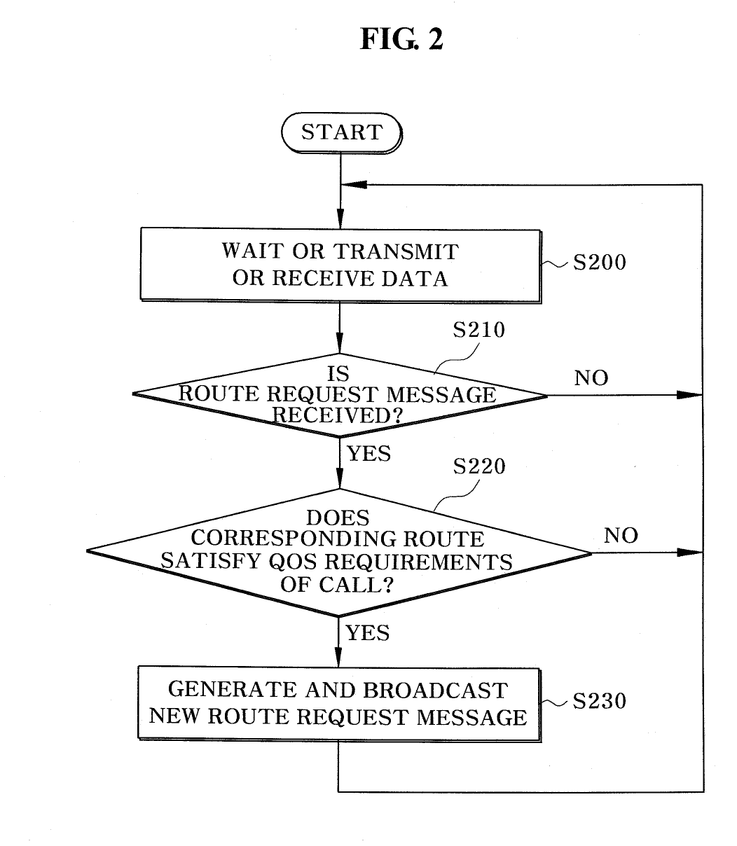

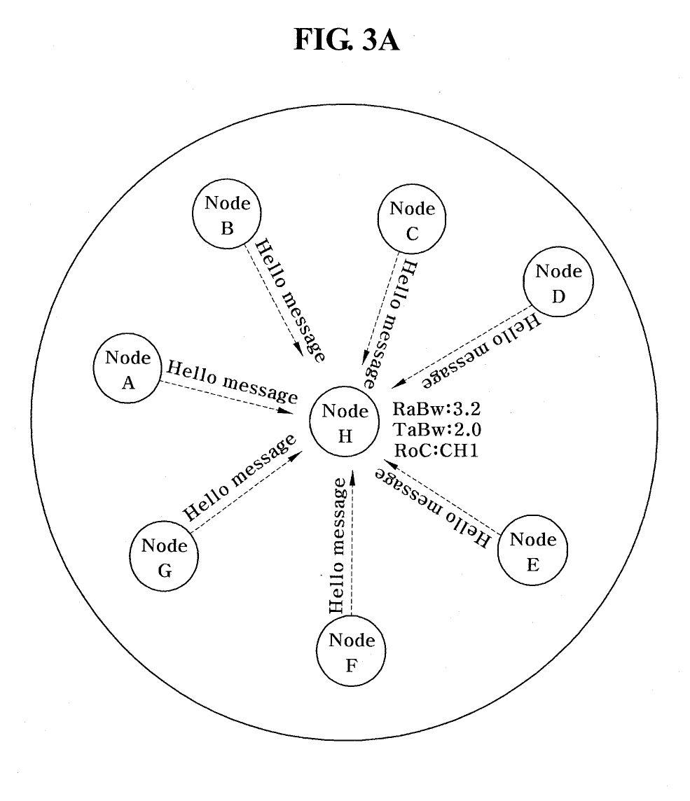

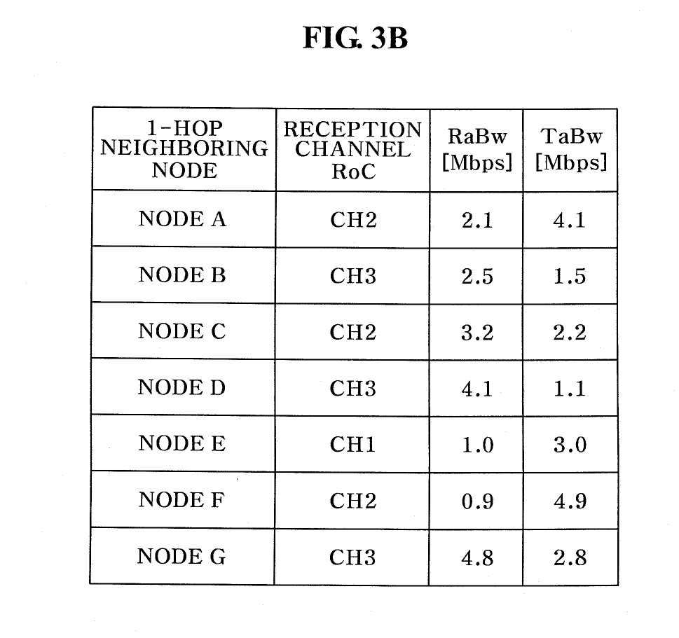

FIG. 2 is a flowchart showing a method of relaying a route request message according to an exemplary embodiment of the present invention, and FIGS. 3A and 3B are a diagram and a table for describing the exemplary embodiment of FIG. 2.

Assuming that radio channels which can be used without interference are CH0, CH1, CH2 and CH3 in a wireless ad-hoc network of FIGS. 3A and 3B, that CH0 is allocated as a dedicated control channel, and that a node H in FIG. 3A performs the exemplary embodiment of FIG. 2, the exemplary embodiment of FIG. 2 will be described below.

In step 200, each of wireless nodes in the wireless ad-hoc network transmits data to a neighboring node through a transmission interface or receives data from a neighboring node through a reception interface. In addition, each of the wireless nodes transmits/receives control data, such as a hello message and a route request message, through a control interface.

Referring to FIG. 3A, node H transmits control data through CH0 and receives data through CH1. Therefore, the transmission interface of node H can use CH2 and CH3, and one of CH2 and CH3 is selected and used for transmission.

Each of the wireless nodes transmits a hello message periodically or when an event such as a change in network situation occurs. The hello message according to an exemplary embodiment of the present invention includes information on an available transmission bandwidth (a bandwidth that can be used for transmission) TaBw, an available reception bandwidth RaBw (a bandwidth that can be used for reception) and a reception channel RoC. Therefore, each of the wireless nodes must estimate its own available transmission bandwidth and available reception bandwidth to broadcast the hello message.

The available transmission bandwidth TaBw, that is, the amount of traffic which can be additionally transmitted in the future may be estimated, for example, on the basis of statistics on the amount of traffic transmitted by the transmission interface of the wireless node. In the same way, the available reception bandwidth RaBw, that is, the amount of traffic which can be additionally received in the future may be estimated on the basis of statistics on the amount of traffic received by the reception interface.

Referring to FIG. 3A, node H estimates the available reception and transmission bandwidths RaBw and TaBw and then broadcasts a hello message including information that RaBw=3.2 Mbps, TaBw=2.0 Mbps, and RoC=CH1. In the same way, other nodes A, B, C, D, E, F and G also estimate their available transmission and reception bandwidths and then broadcast hello messages including information on the estimated available transmission and reception bandwidths and their reception channels. By receiving the hello messages broadcast from the respective neighboring nodes A to G, node H can obtain information as shown in FIG. 3B.

When it is determined in step 210 that a route request message is received during a standby operation, a transmission operation or a reception operation in step 200, the process proceeds to step 220. Otherwise, step 200 continues. For example, when node H receives a route request message from one of the neighboring nodes A to G in FIG. 3, e.g., node A, the operation of step 220 is performed.

In step 220, it is determined whether or not the corresponding route satisfies Quality of Service (QoS) requirements of a call related to the received route request message. Here, the QoS requirements may be, for example, a bandwidth requirement, a delay requirement, and so on.

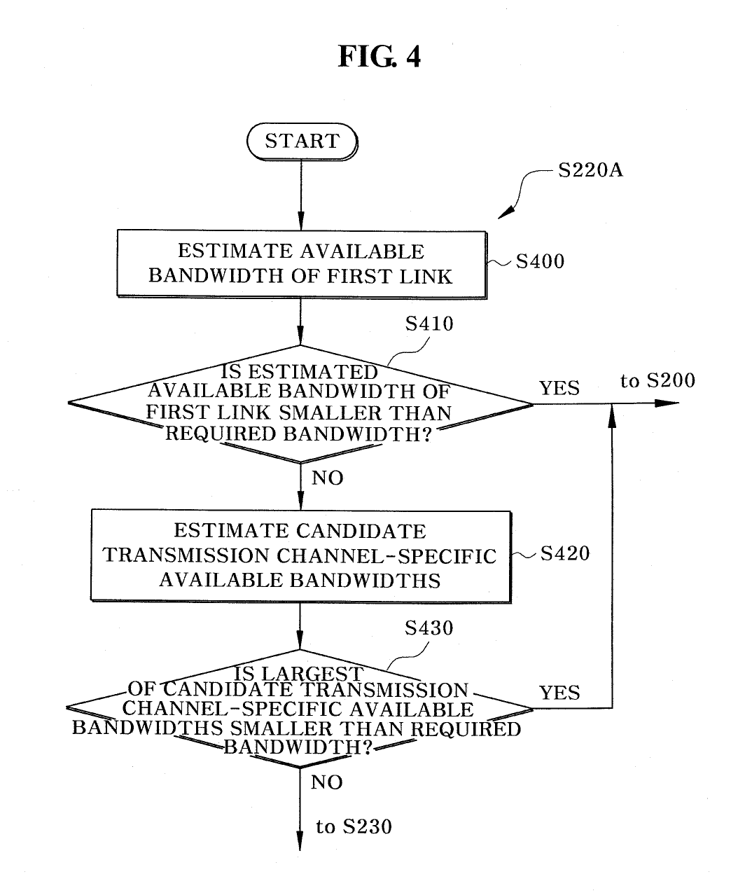

Step 220 concerning the bandwidth requirement is performed as follows according to an exemplary embodiment of the present invention. An intermediate node receiving the route request message determines whether or not a condition that a link from a node transmitting the route request message to the intermediate node itself and a link from the intermediate node to one of one or more neighboring nodes both have an available bandwidth equal to or larger than a required bandwidth, is satisfied. This will be described in detail later with reference to FIG. 4.

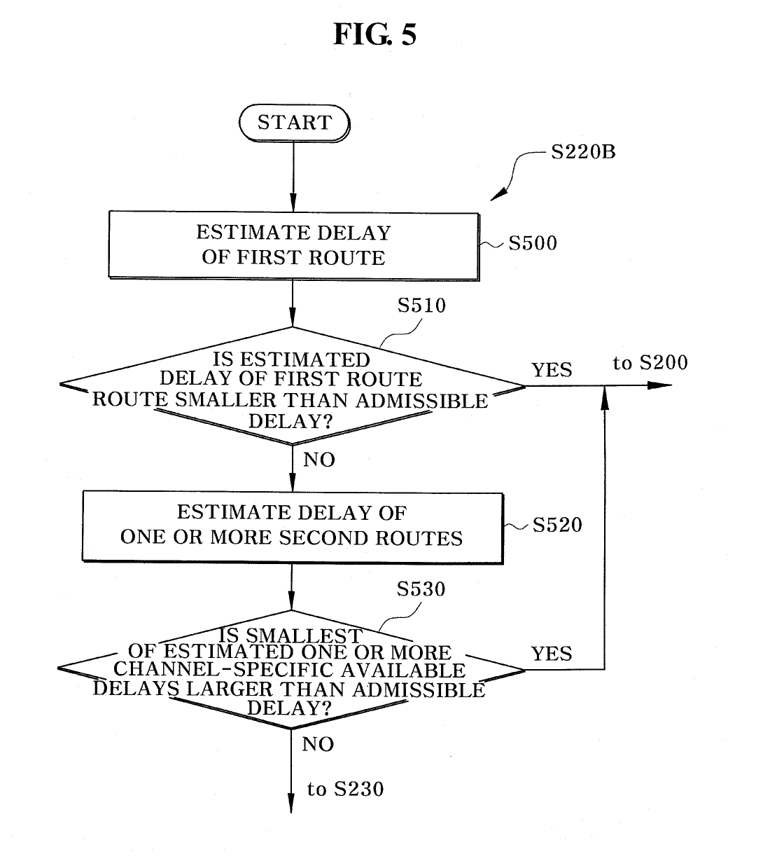

Step 220 concerning the delay requirement is performed as follows according to an exemplary embodiment of the present invention. An intermediate node receiving the route request message estimates a delay from a source node (not shown) to each of the one or more neighboring nodes, and determines whether or not one of the estimated delays is equal to or smaller than an admissible delay. This will be described in detail later with reference to FIG. 5.

When it is determined in step 220 that the corresponding route satisfies the QoS requirements of the call, the wireless node receiving the route request message generates and broadcasts a new route request message to continue a route configuration process (step 230). Otherwise, the process returns to step 200.

In other words, in step 230, the route request message is relayed, and a route guaranteeing the QoS requirements is configured when the route request message is transferred to a destination node.

FIG. 4 is a flowchart showing a detailed process of step 220 of FIG. 2 when a QoS requirement is a bandwidth requirement.

Referring to FIG. 4, step 220 of FIG. 2 starts from step 400.

In step 400, node H of FIG. 3A estimates an available bandwidth UsBw of a first link. Here, the first link denotes a wireless link from the node, i.e., node A, that transmitted the route request message to node H, and the available bandwidth denotes a bandwidth admissible on the corresponding wireless link.

According to an exemplary embodiment, node H determines the minimum of its own available reception bandwidth and available transmission bandwidth as the available bandwidth UsBw. In this way, the available bandwidth UsBw of the first link can be obtained in the situation of FIGS. 3A and 3B, as shown in Equation (1) below.

UsBw=min{RaBw(node H), TaBw(node A)}=min{3.2, 4.1}=3.2 Mbps Equation (1)

Here, RaBw(node H) is a value estimated by node H itself as illustrated in FIG. 3A, and TaBw(node A) is information that can be obtained from the hello message previously received by node H from node A as illustrated in FIG. 3B.

When it is determined in step 410 that the estimated available bandwidth UsBw of the first link is equal to or larger than the required bandwidth, the process proceeds to step 420. Otherwise, the process returns to step 200 of FIG. 2.

Meanwhile, node H must know the required bandwidth to compare the available bandwidth UsBw with the required bandwidth in step 410. Information on the required bandwidth may be included in a route request message and relayed, such that node H can find out the required bandwidth. In other words, the route request message may include information on the required bandwidth of the call.

In step 420, the wireless node, i.e., node H, receiving the route request message estimates candidate transmission channel-specific available bandwidths. More specifically, node H produces available bandwidths of one or more candidate transmission channels which can be used by the transmission interface of node H. Here, each of the candidate transmission channel-specific available bandwidths is the smallest of the available transmission bandwidth of node H and each of available reception bandwidths of the neighboring nodes A to G using the candidate transmission channels as reception channels. Meanwhile, according to another exemplary embodiment, node A, the wireless node that transmitted the route request message, may not be considered in the estimation step, i.e., step 420. However, for convenience, this exemplary embodiment will be described in consideration of node A in the estimation step.

Referring to FIG. 3A, the candidate transmission channels of node H are CH2 and CH3, which are channels other than the dedicated control channel CH0 and the reception channel CH1. Referring to FIGS. 3A and 3B, available bandwidths aBw(CH2) and aBw(CH3) of the candidate transmission channels CH2 and CH3 may be obtained from Equations (2) and (3) below.

aBw(CH2)=min{RaBw(Node A), RaBw(Node C), RaBw(Node F), TaBw(Node H)}=min{2.1, 3.2, 0.9, 2.0}=0.9 Equation (2)

aBw(CH3)=min{RaBw(Node B), RaBw(Node D), RaBw(Node G), TaBw(Node H)}min{2.5, 4.1, 4.8, 2.0}=2.0 Equation (3)

In step 430, node H produces the largest available bandwidth and determines whether or not the produced largest available bandwidth is equal to or larger than the required bandwidth. According to an exemplary embodiment, node H determines the maximum of the one or more candidate transmission channel-specific available bandwidths produced in step 420 as the largest available bandwidth, and then compares it with the required bandwidth.

Referring to the example results of step 420 and FIG. 3A, the largest available bandwidth may be obtained from Equation (4) below.

aBw=max{aBw(CH2), aBw(CH3)}=max{0.9, 2.0}=2.0 Equation (4)

In result, a link having the largest available bandwidth is from node H to node G, and a QoS guarantee route from the source node to the destination node is likely to pass through the nodes A, H and G.

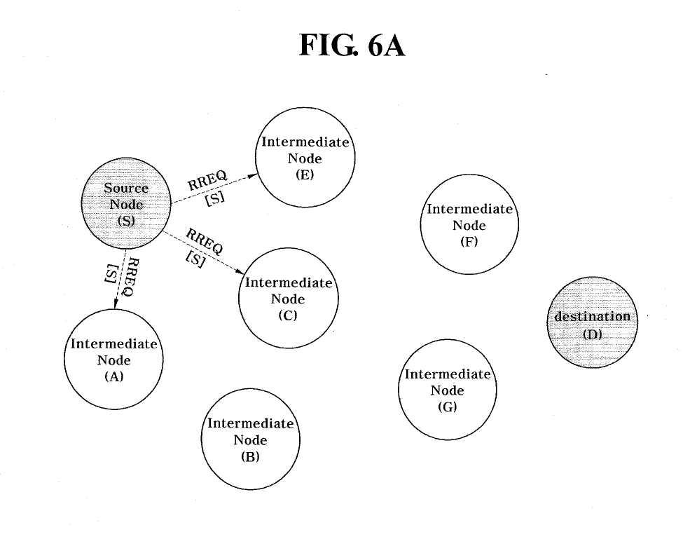

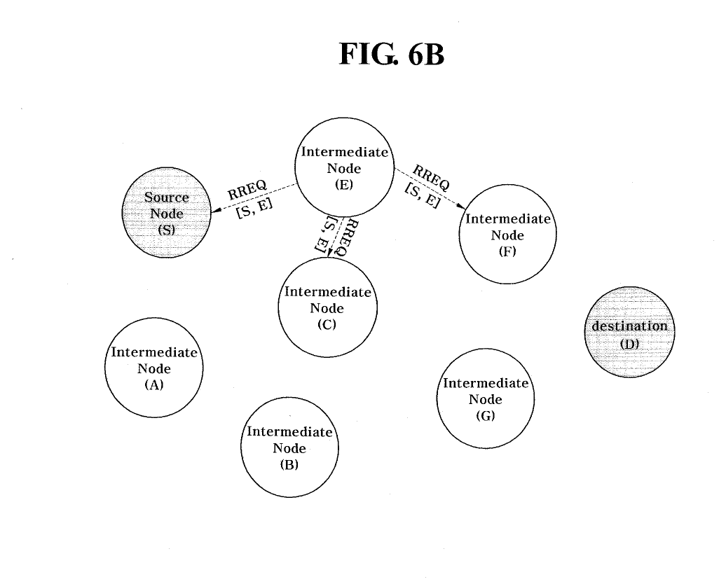

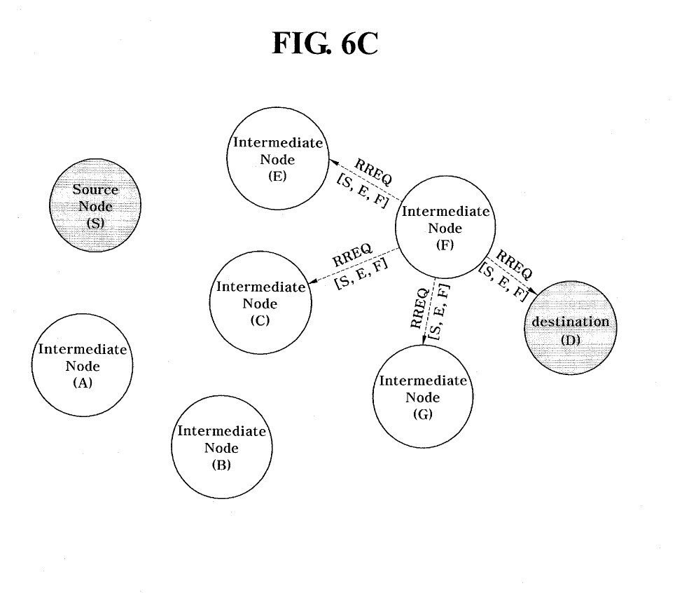

When it is determined in step 430 that the bandwidth requirement is satisfied, the process proceeds to step 230 of FIG. 2, and a new route request message including the information on the required bandwidth is generated and broadcast. Contents of the route request message will be described later with reference to FIGS. 6A to 6C.

FIG. 5 is a flowchart showing a detailed process of step 220 of FIG. 2 when a QoS requirement is a delay requirement.

According to the exemplary embodiment of FIG. 5, the route request message includes information on the admissible delay and a delay of a route from the source node to the wireless node, i.e., node A, that transmitted the route request message.

Referring to FIG. 5, step 220 of FIG. 2 starts from step 500.

In step 500, node H estimates a delay of a first route. Here, the first route denotes a route from the source node (not shown) which initially transmitted the route request message to node H, and includes the route from the source node to node A and a link from node A to node H.

The delay of the first route may be estimated by Equation (5) according to an exemplary embodiment of the present invention.

Delay of first route=Delay of route from source node to node A+Delay of link from node A to node H Equation (5)

Here, information on the delay of the route from the source node to node A is included in the route request message and received by node H, and the delay of the link from node A to node H may be calculated by Equation (6).

Delay of link from node A to node H=required bandwidth/UsBw of link from node A to node H Equation (6)

Here, UsBw of the link from node A to node H is obtained by Equation (1) described above with reference to FIG. 4.

For calculation of Equation (6), information on the required bandwidth may be included in the route request message according to an exemplary embodiment of the present invention.

When it is determined in step 510 that the estimated delay of the first route is equal to or smaller than the admissible delay, the process proceeds to step 520. Otherwise, the process returns to step 200 of FIG. 2.

In step 520, node H estimates delays of one or more second routes.

Here, the second routes consist of the first route and each of links from the intermediate node receiving the route request message to neighboring nodes.

Referring to FIGS. 3A and 3B, there are seven neighboring nodes A to G and seven second routes. Here, node A is the wireless node that transmitted the route request message, and thus may be excluded from the delay estimation process of step 520 according to an exemplary embodiment of the present invention.

Among the seven second routes, node H may estimate delays of four second routes obtained on the basis of neighboring nodes B, D, E and G, excluding neighboring nodes A, C and F which use the same reception channel CH1 as node H itself.

Node H may estimate a delay of a second route alone based on node G, which is a wireless node related to the largest available bandwidth obtained according to the exemplary embodiment of FIG. 4. The delay of the second route based on node G may be estimated using Equation (7) below.

Delay of second route including link to node G=Delay of first route+Delay of link from node H to node G Equation (7)

Here, the delay of the link from node H to node G may be calculated using Equation (8).

Delay of link from node H to node G=required bandwidth/aBw of link from node H to node G Equation (8)

For calculation using Equation (8), the route request message may include information on the required bandwidth according to an exemplary embodiment of the present invention.

When it is determined in step 530 that the minimum of one or more delays estimated in step 520 is larger than the admissible delay, the process returns to step 200 of FIG. 2. Otherwise, the process proceeds to step 230 of FIG. 2.

More specifically, when the delay requirement is satisfied in step 530, the process proceeds to step 230 of FIG. 2, and node H generates and broadcasts a new route request message including information on the admissible delay and the delay of the first route estimated in step 500.

The method of relaying a route request message according to an exemplary embodiment of the present invention can be applied to all route request message-based route configuration techniques such as Dynamic Source Routing (DSR) and Ad-hoc On-demand Distance Vector routing (AODV).

FIGS. 6A to 6C illustrate a DSR scheme employing a method of configuring a QoS guarantee route.

Referring to FIG. 6A, a source node S broadcasts a first route request message, and intermediate nodes A, C and E neighboring the source node S receive the first route request message.

Each of the intermediate nodes A, C and E determine whether or not a route including itself satisfies QoS requirements included in the received first route request message. In other words, the intermediate nodes A, C and E perform the operation of step 220 of FIG. 2.

FIG. 6B illustrates a case in which only the intermediate node E among the intermediate nodes A, C and E satisfies the QoS requirements of step 220 and performs step 230. In other words, a route based on the intermediate node E satisfies the QoS requirements and generates and broadcasts a second route request message. In result, the source node S and the intermediate nodes C and F neighboring the intermediate node E receive the second route request message.

Referring to FIG. 6C, the intermediate node F receives the second route request message, determines whether or not the QoS requirements are satisfied, and then broadcasts a third route request message. In result, a destination node D receives the third route request message and transmits a route response message. The route response message is transmitted to the source node S via the intermediate nodes F and E, and finally a QoS guarantee route is configured.

Meanwhile, the first to third route request messages may include information, e.g., information on the corresponding route, included in a route request message according to the conventional DSR scheme, and may also include information on a required bandwidth, an admissible delay and a delay of a route from a source node to a previous node according to an exemplary embodiment of the present invention. For example, the second route request message may include information on the corresponding route, i.e., from the source node S to the intermediate node E, the required bandwidth, the admissible delay and a delay of the route from the source node S to the intermediate node E.

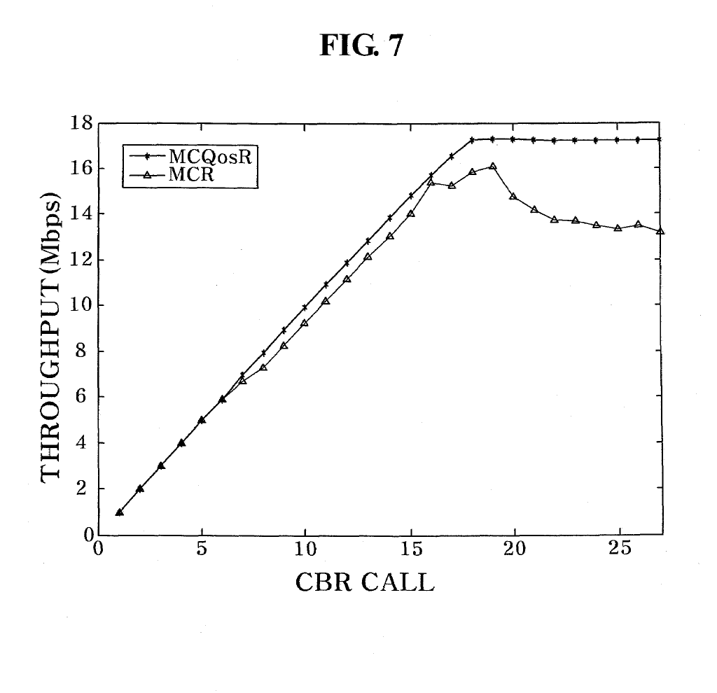

FIG. 7 shows throughput simulation results of a method of configuring a route guaranteeing a required bandwidth and an admissible delay according to an exemplary embodiment of the present invention, i.e., Multiple Channel Quality of Service Routing (MCQoSR), and a conventional method of configuring a route without considering QoS, i.e., Minimum Cell Rate (MCR).

FIG. 7 is obtained in a simulation environment in which one hundred wireless nodes are disposed in a grating having a length and width of 900 m, and a call of a Constant Bit Rate (CBR) of 1 Mbps is successively made.

Referring to FIG. 7, congestion occurs when about seventeen calls are made, and the difference in performance between the MCR and the MCQoSR becomes remarkable after the congestion occurs. The MCQoSR performs call admission control in consideration of QoS and reduces congestion, which results in the remarkable difference in performance. In other words, according to the MCQoSR, a call is denied when QoS cannot be guaranteed in a network, and the QoS is guaranteed for only admitted calls.

The present invention can be embodied in a recording medium that can be read by a machine, such as a computer, using a machine-readable code. The machine-readable recording medium includes every recording device that stores machine-readable data. The machine-readable recording medium may be a read-only memory (ROM), a random access memory (RAM), a compact disk read-only memory (CD-ROM), a magnetic tape, a floppy disk, an optical data storage device, and so on. Also, the machine-readable recording medium may be carrier waves, e.g., transmission over the Internet. In addition, the machine-readable recording medium may be distributed to machine systems connected via a network, and the machine-readable code may be stored and executed by a de-centralized method. A functional program, a code, and code segments for embodying the present invention can be easily deduced by programmers in the technical field of the present invention.

The above-described embodiments of the present invention may have effects including the following advantages. However, it does not mean that all the embodiments of the present invention must include all the advantages, and thus the scope of the present invention is not limited by the advantages.

According to an exemplary embodiment of the present invention, a route guaranteeing QoS required for a call can be efficiently configured.

According to an exemplary embodiment of the present invention, network resources can be efficiently used even in a congested environment in comparison with a method that does not perform call admission control concerning QoS.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A method of estimating at a first node available bandwidth of a link from a second node to the first node in a multi-channel multi-interface based wireless ad-hoc network, the method comprising:
receiving a message broadcast from the second node, wherein the message comprises information on an available transmission bandwidth of the second node;
estimating an available reception bandwidth of the first node; and
determining the smaller of the available transmission bandwidth and the available reception bandwidth as the available link bandwidth, wherein:
the first node in the wireless ad-hoc network has a transmission interface, a reception interface, and a control interface using different channels,
the second node in the wireless ad-hoc network has a transmission interface, a reception interface, and a control interface using different channels, and
the message is transmitted from the control interface of the second node and received by the control interface of the first node through a dedicated control channel of the wireless ad-hoc network.

2. The method of claim 1, wherein:
the first node and the second node in the wireless ad-hoc network uses a fixed reception channel used by the reception interface; and
the first node and the second node selects and uses available channels in the wireless ad-hoc network, besides the reception channel and the dedicated control channel, as a transmission channel.

3. The method of claim 1, wherein said estimating and said determining are performed only when a channel used by the reception interface of the second node is different from a channel used by the reception interface of the first node.

4. A method of estimating at a first node available bandwidth of a link from the first node to a second node in a multi-channel multi-interface based wireless ad-hoc network, the method comprising:
receiving a message broadcast from the second node, wherein the message comprises information on an available reception bandwidth of the second node;
estimating an available transmission bandwidth of the first node; and
determining the smaller of the available transmission bandwidth and the available reception bandwidth as the available link bandwidth, wherein:
the first node in the wireless ad-hoc network has a transmission interface, a reception interface, and a control interface using different channels,
the second node in the wireless ad-hoc network has a transmission interface, a reception interface, and a control interface using different channels, and
the message is transmitted from the control interface of the second node and received by the control interface of the first node through a dedicated control channel of the wireless ad-hoc network.

5. A method of a first node receiving a route request message to estimate a delay of a route from a source node to the first node in a multi-channel multi-interface based wireless ad-hoc network, the method comprising:
receiving the route request message, wherein the route request message comprises information on a delay from the source node to a second node and a required bandwidth from the second node;
estimating an available bandwidth of a link for transmission from the second node to the first node;
estimating a delay of the link from the second node to the first node on the basis of the available link bandwidth and the required bandwidth; and
determining a sum of the estimated delay and the delay included in the route request message as the delay of the route.

6. A method of a first node receiving a route request message to estimate a delay of a route from a source node through the first node to a second node neighboring the first node in a multi-channel multi-interface based wireless ad-hoc network, the method comprising:
receiving the route request message including information on a required bandwidth;
estimating a delay of a link from the source node to the first node;
estimating an available bandwidth of a link from the first node to the second node;
estimating a delay of the link from the first node to the second node on the basis of the available link bandwidth and the required bandwidth; and
determining the delay of the route as a sum of said delay of a link from the source node to the first node and said delay of the link from the first node to the second node.

7. A method of an intermediate node to relay a route request message for route configuration in a multi-channel multi-interface based wireless ad-hoc network, the method comprising:
receiving a first route request message including information on a required bandwidth;
determining if a link from a node transmitting the first route request message to the intermediate node and a link from the intermediate node to one of at least one neighboring nodes have an available bandwidth equal to or greater than the required bandwidth; and
if it is determined that the link from the node transmitting the first route request message to the intermediate node and the link from the intermediate node to one of at least one neighboring nodes has the available bandwidth equal to or greater than the required bandwidth, then broadcasting a second route request message comprising the information on the required bandwidth.

8. The method of claim 7, wherein:
each node in the wireless ad-hoc network has a transmission interface and a reception interface using different channels; and
said at least one neighboring nodes use, as a reception channel, one of one or more candidate transmission channels that can be used by a transmission interface of the intermediate node.

9. The method of claim 7, wherein said determining comprises:
estimating a bandwidth admitted on a link from the node transmitting the first route request message to the intermediate node;
if the bandwidth estimated in said estimating the bandwidth admitted on the link from the node transmitting the first route request message to the intermediate nod is equal to or larger than the required bandwidth, then detecting a link having a largest available bandwidth from links from the intermediate node to said at least one neighboring nodes; and
determining if the largest available bandwidth is equal to or larger than the required bandwidth.

10. The method of claim 9, comprising, prior to said broadcasting:
estimating a delay of a route from a source node through the intermediate node to a neighboring node related to the link having the largest available bandwidth, wherein:
the first route request message comprises information on an admissible delay,
if it is determined that the link from the node transmitting the first route request message to the intermediate node and the link from the intermediate node to one of at least one neighboring nodes has the available bandwidth equal to or greater than the required bandwidth and the estimated delay is equal to or smaller than the admissible delay, then broadcasting the second route request message, and
the second route request message comprises information on the admissible delay and a delay from the source node to the intermediate node.

11. The method of claim 9, wherein:
each node in the wireless ad-hoc network has a transmission interface and a reception interface using different channels; and
said detecting the link having the largest available bandwidth from links from the intermediate node to said at least one neighboring nodes comprises:
calculating an available bandwidth for each of at least one candidate transmission channels which can be used by the transmission interface of the intermediate node, wherein the available bandwidth of a corresponding candidate transmission channel is a smallest available reception bandwidths of said at least one neighboring nodes using the corresponding candidate transmission channel and an available transmission bandwidth of the intermediate node; and
determining a largest of the calculated available bandwidths as the largest available bandwidth.

12. A method of an intermediate node to relay a route request message for route configuration in a multi-channel multi-interface based wireless ad-hoc network, the method comprising:
receiving a first route request message, wherein the first route request message comprises information on an admissible delay;
estimating a delay from a source node to each of at least one neighboring nodes; and
if one of the estimated delays is equal to or smaller than the admissible delay, then broadcasting a second route request message, wherein the second route request message comprises information on the admissible delay.

13. The method of claim 12, wherein:
each node in the wireless ad-hoc network has a transmission interface and a reception interface using different channels; and
said at least one neighboring nodes use, as a reception channel, one of at least one candidate transmission channels that can be used by the transmission interface of the intermediate node.

14. The method of claim 12, wherein the second route request message comprises information on a delay from the source node to the intermediate node.
